(19) United States
(12) Patent Application Publication
(10) Pub. No.: US 2023/0071051 A1
(43) Pub. Date: Mar. 9, 2023

(54) EDIBLE OIL/FAT COMPOSITION HAVING BACTERIOSTATIC EFFECT

(71) Applicants: J-OIL MILLS, INC., Tokyo (JP); NIPPN CORPORATION, Tokyo (JP)

(72) Inventors: Hiroichi KATSUYAMA, Tokyo (JP); Mayumi TAKAHASHI, Tokyo (JP); Moriyoshi KANAI, Tokyo (JP); Miki NAGAO, Tokyo (JP); Kiho IMAMURA, Kanagawa (JP); Kiwamu KANNO, Kanagawa (JP); Riki HIROSHIMA, Tokyo (JP); Masanori KAWAHARA, Tokyo (JP)

(21) Appl. No.: 17/757,165

(22) PCT Filed: Dec. 18, 2020
(86) PCT No.: PCT/JP2020/047441

§ 371 Date: Jun. 10, 2022

(30) Foreign Application Priority Data
Dec. 17, 2019 (JP) 2019-227787

(51) Int. Cl. A23D 9/007; A23L 29/00

(52) U.S. Cl. CPC A23D 9/007; A23L 29/03; A23V 2200/10; A23V 2200/222

(57) ABSTRACT

Provided is an edible oil/fat composition having a bacteriostatic effect in addition to the functions of conventional edible oils and fats. The problem is solved by the edible oil/fat composition characterized by containing 70% by mass or more of an edible oil/fat, 0.002-10% by mass of a lipophilic bacteriostatic agent, and 0.1-10% by mass of an emulsifier.

### TECHNICAL FIELD

The present invention relates to an edible oil and fat composition having a bacteriostatic effect.

### BACKGROUND ART

Conventionally, in processed food products that use oils and fats, such as fried rice, the stir-fry oil has no bacteriostatic effect, and a shelf life improver is added to the ingredients to extend the expiration date after stir-frying. Similarly, a seasoning oil used to prevent sticking of pasta does not have a bacteriostatic effect. If the seasoning oil has a bacteriostatic effect, the bacteriostatic effect is achieved on a contact surface between the pasta and the seasoning oil. If a bacteriostatic effect can be obtained in the ingredients and the oil and fat in contact with the ingredients, it is possible to reduce the amounts of additives such as shelf life improvers and extend the expiration date.

As a method of using oils and fats to suppress the acidic taste of organic acids, Japanese Unexamined Patent Application Publication No. 2008-220263 proposes a low oil content acidic oil-in-water type emulsified oil and fat composition containing a thickening stabilizer, whey minerals, and an acidulant (Patent Document 1). The oil and fat content of the low oil content acidic oil-in-water type emulsified oil and fat composition is 5 to 40 mass %. Further, Japanese Unexamined Patent Application Publication No. 2019-150068 proposes a method in which an oil and fat composition containing an emulsifier having an HLB of 4.7 to 8 and an edible oil and fat is used for stir-fry cooking, but the purpose of the method is to facilitate the stir-fry cooking and to improve the texture and taste of food products prepared by the stir-fry cooking (Patent Document 2). Moreover, Japanese Unexamined Patent Application Publication No. 2019-58121 proposes a bacteriostatic agent for food products containing oil- and fat-modified starch and acid, by which the acidic taste given to the food product can be suppressed, but the total amount of edible oil and fat and emulsifier is 0.01 to 10 parts by mass with respect to 100 parts by mass of starch (Patent Document 3).

Conventionally, oils and fats have been used to suppress the acidic taste of bacteriostatic agents for food products. However, there is no edible oil and fat composition having the purpose of providing a bacteriostatic effect in food processing, and there is a desire to reduce additives and extend the expiration date by using such an edible oil and fat composition.

### PRIOR ART DOCUMENT

### Patent Document

Patent Document 1: Japanese Unexamined Patent Application Publication No. 2008-220263

Patent Document 2: Japanese Unexamined Patent Application Publication No. 2019-150068

Patent Document 3: Japanese Unexamined Patent Application Publication No. 2019-58121

### SUMMARY OF THE INVENTION

### Problems to be Solved by the Invention

Edible oils and fats conventionally used in food processing are used for preventing noodles from sticking to each other, for stir-fry cooking, for improving the detachability of cooked rice from a rice cooker, and the like. On the other hand, there is a demand for reducing the amounts of additives used from the viewpoint of health consciousness of consumers and a demand for extending the expiration date to reduce food waste. That is, by adding a bacteriostatic function to the functions of a conventional edible oil and fat, it is possible to provide a more efficient bacteriostatic method. Therefore, an object of the present invention is to provide an edible oil and fat composition having a bacteriostatic effect.

### Solution to Problem

As a result of diligent studies to solve the above problems, the present inventors have found that, by adding a specific emulsifier to an edible oil and fat composition containing an edible oil and fat, acetic acid, a lipophilic bacteriostatic agent, and an emulsifier, a more efficient bacteriostatic effect is possible without adding a large amount of bacteriostatic agent, which led to the completion of the present invention.

That is, the present invention provides an edible oil and fat composition characterized in containing an edible oil and fat, a lipophilic bacteriostatic agent, and an emulsifier.

The present invention also provides a food product obtained by adding the edible oil and fat composition.

### Advantageous Effect of the Invention

By the edible oil and fat composition having the bacteriostatic effect according to the present invention, it is possible to provide a bacteriostatic effect in addition to functions as seasoning oil for pasta and stir-fry oil used in stir-fry cooking, or functions such as improving the detachability of cooked rice from a rice cooker. Thus, the edible oil and fat composition according to the present invention can achieve not only the functions of conventional edible oils and fats, but also improving the storage stability of food products.

### BRIEF DESCRIPTION OF DRAWINGS

FIG. 1 is a table showing results of examining the dispersibility of a lipophilic bacteriostatic agent.

FIG. 2 is a table showing results of examining the dispersibility of the lipophilic bacteriostatic agent.

FIG. 3 is a table showing results of examining the dispersibility of the lipophilic bacteriostatic agent.

FIG. 4 is a table showing results of examining the dispersibility of the lipophilic bacteriostatic agent.

FIG. 5 is a table showing results of examining the dispersibility of the lipophilic bacteriostatic agent.

### DESCRIPTION OF THE EMBODIMENT

An embodiment of an edible oil and fat composition according to the present invention will be described.

The type of edible oil and fat used in the present embodiment is not particularly limited, but examples thereof include vegetable oils such as soybean oil, rapeseed oil, rice oil, sesame oil, rice bran oil, peanut oil, safflower oil, sunflower oil, cottonseed oil, grape seed oil, macadamia nut oil, hazelnut oil, walnut oil, pumpkin seed oil, camellia oil, tea seed oil, palm oil, palm olein, sunflower oil, olive oil, palm kernel oil, coconut oil, and cacao butter, animal oils and fats such as beef tallow, lard, fish oil, and milk fat, synthetic oils and fats such as medium chain fatty acid triglyceride, and the like. Further, these oils and fats can be subjected to one or more processes selected from hardening, fractionation, and transesterification, and the processed oil thus obtained can be used as the edible oil and fat. Moreover, it is possible to use processed oil and fat products such as shortening obtained by hydrogenating unsaturated fatty acids. These edible oils and fats may be used alone or in a combination of two or more oils and fats.

The content of the edible oils and fats is preferably 70 mass % or more from the viewpoint of exhibiting a conventional functionality. On the other hand, if the content of the edible oils and fats is less than 70 mass %, conventional functionalities such as preventing noodles from sticking to each other and improving detachability of cooked rice decrease.

The edible oil and fat composition according to the present embodiment contains acetic acid. The acetic acid being used may be a pure product (glacial acetic acid) or a water-containing product (hydrate). The content of the acetic acid is preferably from 0.1 to 10 mass %, and more preferably from 0.5 to 5 mass %. By setting the content of acetic acid within such a range, the solubility in the edible oil and fat and the bacteriostatic effect can be improved.

Examples of the lipophilic bacteriostatic agent used in the present embodiment include thiamine dilaurylsulfate listed in Appended Table 1 of Regulations for Enforcement of the Food Sanitation Act, yucca extract, mustard extract, capsicum extract, and licorice oil extract listed in the register of List of Existing Food Additives, hop extract listed in General Food and Drink Additives, and the like. These lipophilic bacteriostatic agents may be used alone or in a combination of two or more of the lipophilic bacteriostatic agents. Here, “lipophilic” refers to a property of being easily dissolved in oil or a non-polar solvent, and “bacteriostatic agent” refers to an agent that does not have an effect of killing target microorganisms such as bacteria, but has an effect of suppressing the growth and proliferation of such microorganisms (bacteriostatic effect).

The content of the lipophilic bacteriostatic agent is changed appropriately depending on the solubility of an active ingredient having the bacteriostatic effect in the edible oil and fat, but the content is preferably from 0.002 to 10 mass %. By setting the content of the lipophilic bacteriostatic agent within such a range, the edible oil and fat composition can be imparted with the bacteriostatic effect.

The pH of the lipophilic bacteriostatic agent is preferably 1.3±0.3.

An emulsifier used in the present embodiment includes one or more types selected from the group consisting of diglycerol ester, monoglycerol esters of organic acids, sucrose fatty acid ester, polyglycerol condensed ricinoleic acid ester, polyglycerol fatty acid ester, monoglycerol fatty acid ester, sorbitan fatty acid ester, and propylene glycol fatty acid ester, and preferably, the emulsifier includes one or more types selected from the group consisting of monoglycerol esters of organic acids, sucrose fatty acid ester, polyglycerol condensed ricinoleic acid ester, polyglycerol fatty acid ester, monoglycerol fatty acid ester, and propylene glycol fatty acid ester.

The content of the emulsifier is preferably from 0.1 to 10 mass %, and more preferably from 0.3 to 5 mass %.

The HLB of the emulsifier is preferably from 1 to 8.

Here, regarding “HLB” (hydrophile-lipophile balance), it is assumed that a substance having no hydrophilic group has HLB=0, a substance having only a hydrophilic group and having no lipophilic group has HLB=20, and this range is equally divided. An emulsifier has both lipophilicity and hydrophilicity and thus has an HLB value between 0 and 20. If the hydrophilicity is large compared to the lipophilicity, the HLB value increases and an emulsifier that easily dissolves in water is obtained, and if the hydrophilicity is small compared to the lipophilicity, the HLB value decreases and an emulsifier that does not easily dissolve in water is obtained.

Next, an embodiment of a food product obtained by adding the edible oil and fat composition according to the present invention will be described.

Examples of the food product of the present embodiment include cooked rice products such as cooked white rice, rice balls, takikomi gohan, and pilaf, noodle products such as pasta, soba, and udon, boiled foods such as katsu-ni and chikuzen-ni, stir-fried foods such as fried rice, fried vegetables, and scrambled eggs, grilled foods such as grilled meat and grilled fish, dressed foods such as namul, goma-ae, and namerou, salads such as Caesar salad and potato salad, bakery products such as bread and pizza, processed seafood products such as fish sausage and kamaboko, and the like. Among these food products, cooked rice products, noodle products, and stir-fried foods are preferable.

In addition, the food product can be particularly suitably used in food products processed for distribution such as lunch boxes that require a bacteriostatic agent.

The edible oil and fat composition of the present embodiment can be used similarly as a conventional oil and fat for food processing, and may be used as seasoning oil for noodles, as stir-fry oil used for stir-fry cooking, or as rice cooking oil to be added to rice during cooking. By using the edible oil and fat composition of the present embodiment, the bacteriostatic effect can be imparted to the food product by a similar usage method and at a similar usage amount as those of a conventional oil and fat for food processing.

The present invention will be described in more detail below with reference to examples, but the present invention is not limited to these examples.

### EXAMPLES

1. Evaluation of Preservability of Edible Oil and Fat Composition (Fried Rice)

(1) Preparation of Edible Oil and Fat Compositions

Various types of edible oil and fat compositions were prepared by mixing glacial acetic acid (manufactured by Azuma Co., Ltd.) as the acetic acid, hop extract (manufactured by Asama Kasei Co., Ltd.) as the lipophilic bacteriostatic agent, C8 monoglycerol ester (Sunsoft No. 700P-2 (trademark) manufactured by Taiyo Kagaku Co., Ltd., HLB 7.2), C16C18 succinic acid monoglycerol ester (Myverol (trademark), manufactured by Kerry, Co., Ltd., HLB 4), and C18 sucrose fatty acid ester (0-170 (trademark), manufactured by Mitsubishi Chemical Foods, HLB 1) as emulsifiers, and edible rapeseed oil (Sarasara Canola Oil (trademark) manufactured by J-Oil Mills, Inc.) as the edible oil and fat. Table 1 shows the component ratios of the various types of edible oil and fat compositions.

TABLE 1

| | Component ratios (mass %) of various types of edible oil and fat compositions | | | | | |
|---|---|---|---|---|---|---|
| | | | | C16C18 | C18 | |
| | | | C8 | Succinic acid | Sucrose | Edible |
| | Acetic | Hop | Monoglycerol | monoglycerol | fatty acid | rapeseed |
| | acid | extract | ester | ester | ester | oil |
| Control | 0 | 0 | 0 | 0 | 0 | 100 |
| Example 1 | 3 | 0.05 | 1 | 0 | 0 | 95.95 |
| Example 2 | 3 | 0.05 | 0 | 1 | 0 | 95.95 |
| Example 3 | 3 | 0.05 | 0 | 0 | 1 | 95.95 |
| Comparative | 3 | 0 | 1 | 0 | 0 | 96 |
| Example 1 | | | | | | |
| Comparative | 3 | 0 | 0 | 1 | 0 | 96 |
| Example 2 | | | | | | |
| Comparative | 3 | 0 | 0 | 0 | 1 | 96 |
| Example 3 | | | | | | |
| Comparative | 0 | 0.05 | 1 | 0 | 0 | 98.95 |
| Example 4 | | | | | | |
| Comparative | 0 | 0.05 | 0 | 1 | 0 | 98.95 |
| Example 5 | | | | | | |
| Comparative | 0 | 0.05 | 0 | 0 | 1 | 98.95 |
| Example 6 | | | | | | |

(2) Preservability Test

3.5 g of the edible oil and fat compositions of Examples 1 to 3 and Comparative Examples 1 to 6 were placed in a frying pan. After heating the edible oil and fat composition, 200 g of frozen “Honkaku-Itame Cha-Han” (trademark: manufactured by Nichirei Foods Inc.) were stir-fried for 4 minutes, and then rapidly cooled in a refrigerator to be used in a preservability test at 15° C.

The results are shown in Table 2. In Examples 1 to 3, the general viable cell count was 2 orders or less three days after preparation of the samples, whereas in the Control and Comparative Examples 1 to 6, the general viable cell count was increased to 3 orders or more.

TABLE 2

| | General viable cell count (CFU/g) | |
|---|---|---|
| Test plot | Day 0 | After 3 days |
| Control | <10 | 9.7 × 10⁵ |
| Example 1 | <10 | <10 |
| Example 2 | <10 | 5.9 × 10² |
| Example 3 | <10 | 8.7 × 10² |
| Comparative | <10 | 8.1 × 10³ |
| Example 1 | | |
| Comparative | <10 | 7.3 × 10⁵ |
| Example 2 | | |
| Comparative | <10 | 4.4 × 10⁵ |
| Example 3 | | |
| Comparative | <10 | 3.2 × 10⁵ |
| Example 4 | | |
| Comparative | <10 | 2.9 × 10⁵ |
| Example 5 | | |
| Comparative | <10 | 8.4 × 10⁵ |
| Example 6 | | |

2. Evaluation of Preservability of Edible Oil and Fat Compositions (Dried Spaghetti)

(1) Preparation of Edible Oil and Fat Compositions

Edible oil and fat compositions were prepared by mixing 80% acetic acid (manufactured by Azuma Co., Ltd.) as the acetic acid, hop extract (manufactured by Asama Kasei Co., Ltd.) and thiamine lauryl sulfate (manufactured by Taisho Technos Co., Ltd.) as the lipophilic bacteriostatic agent, C8 monoglycerol ester (Sunsoft No. 700P-2 (trademark) manufactured by Taiyo Kagaku Co., Ltd., HLB 7.2) as the emulsifier, and edible rapeseed oil (Sarasara Canola Oil (trademark) manufactured by J-Oil Mills, Inc.) as the edible oil and fat. Table 3 shows the component ratios of the various types of edible oil and fat compositions.

TABLE 3

| | Component ratios (mass %) of various types | | | | |
|---|---|---|---|---|---|
| | of edible oil and fat compositions | | | | |
| | 80% | | Thiamine | C8 | Edible |
| | Acetic | Hop | lauryl | Monoglycerol | rapeseed |
| | acid | extract | sulfate | ester | oil |
| Control | 0 | 0 | 0 | 0 | 100 |
| Example 4 | 1 | 0.02 | 0.06 | 1 | 97.92 |
| Comparative | 1 | 0 | 0 | 0 | 99 |
| Example 7 | | | | | |
| Comparative | 0 | 0.02 | 0.06 | 0 | 99.92 |
| Example 8 | | | | | |
| Comparative | 0 | 0 | 0 | 1 | 99 |
| Example 9 | | | | | |
| Comparative | 0 | 0.02 | 0.06 | 1 | 98.92 |
| Example 10 | | | | | |
| Comparative | 1 | 0 | 0 | 1 | 98 |
| Example 11 | | | | | |
| Comparative | 1 | 0.02 | 0.06 | 0 | 98.92 |
| Example 12 | | | | | |

(2) Preservability Test

Dried spaghetti (manufactured by Nippon Flour Mills Co., Ltd.) was put into boiling water of an amount 10 times the amount of the spaghetti, boiled for 7 minutes and 30 seconds, and then, the water was drained. The spaghetti was soaked in water at 1 to 10° C. for 1 minute, and the water was drained. Then, the spaghetti was inoculated with Gram-positive bacteria, Gram-negative bacteria, and yeasts which were isolated from pasta lunch boxes commercially available in convenience stores, so that each bacterial strain was 100 CFU/g. The oils and fats of Example 4 and Comparative Examples 7 to 12 were added such that 3% of the oil and fat relative to the spaghetti was included, mixed for 60 seconds, and the obtained samples were used for a preservability test at 10° C. Table 4 shows the results of the preservability test in which the Gram-positive bacteria are inoculated, Table 5 shows the results of the preservability test in which the Gram-negative bacteria are inoculated, and Table 6 shows the results of the preservability test in which yeast is inoculated.

TABLE 4

| | General viable cell count (CFU/g) | |
|---|---|---|
| Test plot | Day 0 | After 4 days |
| Control | 1.0 × 10² | 1.6 × 10⁵ |
| Example 4 | 1.0 × 10² | 2.0 × 10² |
| Comparative | 1.0 × 10² | 1.5 × 10⁵ |
| Example 7 | | |
| Comparative | 1.0 × 10² | 2.6 × 10⁵ |
| Example 8 | | |
| Comparative | 1.0 × 10² | 3.7 × 10⁵ |
| Example 9 | | |
| Comparative | 1.0 × 10² | 3.8 × 10⁵ |
| Example 10 | | |
| Comparative | 1.0 × 10² | 1.8 × 10⁵ |
| Example 11 | | |
| Comparative | 1.0 × 10² | 2.7 × 10⁵ |
| Example 12 | | |

As shown in Table 4, for the sample cooked with the edible oil and fat composition of Example 4, as compared with the Control and Comparative Examples 7 to 12, no increase of the general viable cell count was observed even four days after preparation by inoculating Gram-positive bacteria.

TABLE 5

| | General viable cell count (CFU/g) | |
|---|---|---|
| Test plot | Day 0 | After 4 days |
| Control | 1.0 × 10² | 6.5 × 10⁵ |
| Example 4 | 1.0 × 10² | 3.0 × 10² |
| Comparative | 1.0 × 10² | 1.9 × 10⁵ |
| Example 7 | | |
| Comparative | 1.0 × 10² | 6.1 × 10⁵ |
| Example 8 | | |
| Comparative | 1.0 × 10² | 4.4 × 10⁵ |
| Example 9 | | |
| Comparative | 1.0 × 10² | 3.8 × 10⁵ |
| Example 10 | | |
| Comparative | 1.0 × 10² | 1.2 × 10⁵ |
| Example 11 | | |
| Comparative | 1.0 × 10² | 2.1 × 10⁵ |
| Example 12 | | |

As shown in Table 5, for the sample cooked with the edible oil and fat composition of Example 4, as compared with the Control and Comparative Examples 7 to 12, no increase of the general viable cell count was observed even four days after preparation by inoculating Gram-negative bacteria.

TABLE 6

| | Yeast count (CFU/g) | |
|---|---|---|
| Test plot | Day 0 | After 4 days |
| Control | 1.0 × 10² | 8.0 × 10⁵ |
| Example 4 | 1.0 × 10² | 2.9 × 10² |
| Comparative | 1.0 × 10² | 5.5 × 10⁵ |
| Example 7 | | |
| Comparative | 1.0 × 10² | 5.8 × 10⁵ |
| Example 8 | | |
| Comparative | 1.0 × 10² | 7.7 × 10⁵ |
| Example 9 | | |
| Comparative | 1.0 × 10² | 4.5 × 10⁵ |
| Example 10 | | |
| Comparative | 1.0 × 10² | 2.6 × 10⁵ |
| Example 11 | | |
| Comparative | 1.0 × 10² | 3.2 × 10⁵ |
| Example 12 | | |

As shown in Table 6, for the sample cooked with the edible oil and fat composition of Example 4, as compared with the Control and Comparative Examples 7 to 12, no increase of the yeast count was observed even four days after preparation by inoculating yeast.

3. Evaluation of Preservability of Edible Oil and Fat Compositions (Dried Spaghetti)

(1) Preparation of Edible Oil and Fat Compositions

Edible oil and fat compositions were prepared by mixing glacial acetic acid (manufactured by Mitsubishi Chemical Corporation) as the acetic acid, mustard extract (manufactured by IFF Japan, Inc.) as the lipophilic bacteriostatic agent, C8 monoglycerol ester (POEM M-100 (trademark), manufactured by Riken Vitamin Co., Ltd., HLB 7), polyglycerol fatty acid ester (SY-Glyster CV-1L (trademark), manufactured by Sakamoto Yakuhin Kogyo Co., Ltd., HLB 2.5), polyglycerol condensed ricinoleic acid ester (SY-Glyster CR-ED (trademark), manufactured by Sakamoto Yakuhin Kogyo Co., Ltd., HLB 3), and propylene glycol fatty acid ester (Rikemal PO-100V (trademark), Riken Vitamin Co., Ltd., HLB 3.6) as emulsifiers, and edible rapeseed oil (Sarasara Canola Oil (trademark) manufactured by J-Oil Mills, Inc.) as the edible oil and fat. Table 7 shows the component ratios of the various types of edible oil and fat compositions.

TABLE 7

| | Component ratios (mass %) of various types of edible oil and fat compositions | | | | | | |
|---|---|---|---|---|---|---|---|
| | | | | | Polyglycerol | | |
| | | | C8 | Polyglycerol | condensed | Propylene | Edible |
| | Glacial | Mustard | Monoglycerol | fatty acid | ricinoleic | glycol fatty | rapeseed |
| | acetic acic | extract | ester | ester | acid ester | acid ester | oil |
| Control | 0 | 0 | 0 | 0 | 0 | 0 | 100 |
| Example 5 | 1.5 | 0.03 | 1 | 0 | 0 | 0 | 97.47 |
| Example 6 | 1.5 | 0.3 | 1 | 0 | 0 | 0 | 97.20 |
| Example 7 | 1.5 | 0.3 | 0 | 0.3 | 0 | 0 | 97.90 |
| Example 8 | 1.5 | 0.3 | 1 | 0.3 | 0 | 0 | 96.90 |
| Example 9 | 1.5 | 0.3 | 1 | 0 | 0.4 | 0 | 96.80 |
| Example 10 | 1.5 | 0.3 | 1 | 0 | 0 | 0.3 | 96.90 |
| Comparative | 1.5 | 0 | 1 | 0 | 0 | 0 | 97.50 |
| Example 13 | | | | | | | |

(2) Preservability Test

Dried spaghetti (manufactured by Nippon Flour Mills Co., Ltd.) was put into boiling water of an amount 10 times the amount of the spaghetti, boiled for 7 minutes and 30 seconds, and then, the water was drained. The spaghetti was soaked in water at 1 to 10° C. for 1 minute, and the water was drained. Then, the spaghetti was inoculated with yeasts which were isolated from pasta lunch boxes commercially available in convenience stores, so that each bacterial strain was 100 CFU/g. The oils and fats of Examples 5 to 10 were added such that 3% of the oil and fat relative to the spaghetti was included, mixed for 60 seconds, and the obtained samples were used for a preservability test at 10° C. Table 8 shows the results of the preservability test after inoculation with yeast.

TABLE 8

| | Yeast count (CFU/g) | |
|---|---|---|
| Test plot | Day 0 | After 4 days |
| Control | 1.1 × 10² | 1.2 × 10⁵ |
| Example 5 | 1.1 × 10² | 3.7 × 10² |
| Example 6 | 1.1 × 10² | 5.7 × 10¹ |
| Example 7 | 1.1 × 10² | 3.0 × 10¹ |
| Example 8 | 1.1 × 10² | 9.7 × 10¹ |
| Example 9 | 1.1 × 10² | 4.0 × 10¹ |
| Example 10 | 1.1 × 10² | 4.0 × 10¹ |
| Comparative | 1.1 × 10² | 1.3 × 10⁵ |
| Example 13 | | |

As shown in Table 8, for the samples cooked with the edible oil and fat composition of Examples 5 to 10, as compared with the Control and Comparative Example 13, no increase of the yeast count was observed even four days after preparation by inoculating yeast.

4. Evaluation of Preservability of Edible Oil and Fat Composition (Cooked White Rice)

(1) Preparation of Edible Oil and Fat Compositions

Various types of edible oil and fat compositions were prepared by mixing glacial acetic acid (manufactured by Azuma Co., Ltd.) as the acetic acid, hop extract (manufactured by Asama Kasei Co., Ltd.) and capsicum extract (manufactured by Asama Kasei Co., Ltd.) as the lipophilic bacteriostatic agents, C18 sucrose fatty acid ester (0-170 (trademark), manufactured by Mitsubishi Chemical Foods, HLB 1) as the emulsifier, and edible rapeseed oil (Sarasara Canola Oil (trademark) manufactured by J-Oil Mills, Inc.) as the edible oil and fat. Table 9 shows the component ratios of the various types of edible oil and fat compositions.

TABLE 9

| | Component ratios (mass %) of various types of | | | | |
|---|---|---|---|---|---|
| | edible oil and fat compositions | | | | |
| | Acetic | Hop | Capsicum | C18 Sucrose | Edible |
| | acid | extract | extract | fatty acid ester | rapeseed oil |
| Example 11 | 1 | 0.05 | 0.05 | 1 | 97.9 |
| Comparative | 1 | 0 | 0 | 1 | 98 |
| Example 14 | | | | | |
| Comparative | 0 | 0.05 | 0.05 | 1 | 98.9 |
| Example 15 | | | | | |
| Comparative | 1 | 0.05 | 0.05 | 0 | 98.9 |
| Example 16 | | | | | |

(2) Preservability Test

150 g of polished “Akitakomachi” rice were washed and soaked in water for 15 minutes. After the water was drained, 210 g of water and 1.5 g of each of “Suihanabura” (trademark: J-Oil Mills Inc.) as the Control, and the edible oil and fat compositions of Example 11 and Comparative Examples 14 to 16 were added, and the rice of each sample was cooked in an electric rice cooker. After cooking, the rice was steamed for 10 minutes and then mixed with a spatula. After cooling the cooked rice to room temperature, Bacillus cereus (Bacillus cereus NBRC13494) was inoculated to obtain 10 CFU/g. The cooked white rice of each sample was used for a preservability test at 20° C. The results are shown in Table 10.

TABLE 10

| | Bacillus viable cell count (CFU/g) | | |
|---|---|---|---|
| | Day 0 | First day | Second day |
| Control | 1.0 × 10 | 1.0 × 10⁴ | 6.6 × 10⁵ |
| Example 11 | 1.0 × 10 | 4.2 × 10 | 3.9 × 10³ |
| Comparative | 1.0 × 10 | 7.0 × 10³ | 4.3 × 10⁵ |
| Example 14 | | | |
| Comparative | 1.0 × 10 | 8.8 × 10⁴ | 6.3 × 10⁵ |
| Example 15 | | | |
| Comparative | 1.0 × 10 | 3.2 × 10³ | 2.1 × 10⁵ |
| Example 16 | | | |

As shown in Table 10, for the sample cooked with the edible oil and fat composition of Example 11, there was almost no increase in the bacterial count on the first day after preparation, however, for Comparative Examples 14 to 16, an increase in the bacterial count was observed at an order of 3 to 4.

5. Examination of Dispersion Conditions of Bacteriostatic Agent

The percentage to which the bacteriostatic agent can be dispersed in the edible oil and fat was examined by the following procedure. An edible oil and fat containing edible rapeseed oil (Sarasara Canola Oil (trademark) manufactured by J-Oil Mills, Inc.) as the edible oil and fat, and 2.0 mass % of polyglycerol fatty acid ester (SY-Glyster CV-1L (trademark), manufactured by Sakamoto Yakuhin Kogyo Co., Ltd., HLB 2.5) was prepared. The above-described sample oil and fat and a lipophilic bacteriostatic agent (AR-274 (trademark), manufactured by Asama Co., Ltd.) colored with 1 mass % of red food coloring were put into a 100 mL glass vial, and the glass vial was sealed and strongly shaken up and down 30 times. Subsequently, the obtained sample was stored at room temperature and visually observed how the colored bacteriostatic agent separated. Table 11 shows the blending amounts of the edible oil and fat and the lipophilic bacteriostatic agent.

TABLE 11

| Sample | 1 | 2 | 3 | 4 |
|---|---|---|---|---|
| Lipophilic | 1.0% | 1.5% | 2.0% | 3.0% |
| bacteriostatic agent | | | | |
| Lipophilic | 0.8 | 1.2 | 1.6 | 2.4 |
| bacteriostatic agent (g) | | | | |
| Edible oil and fat (g) | 79.2 | 78.8 | 78.4 | 77.6 |

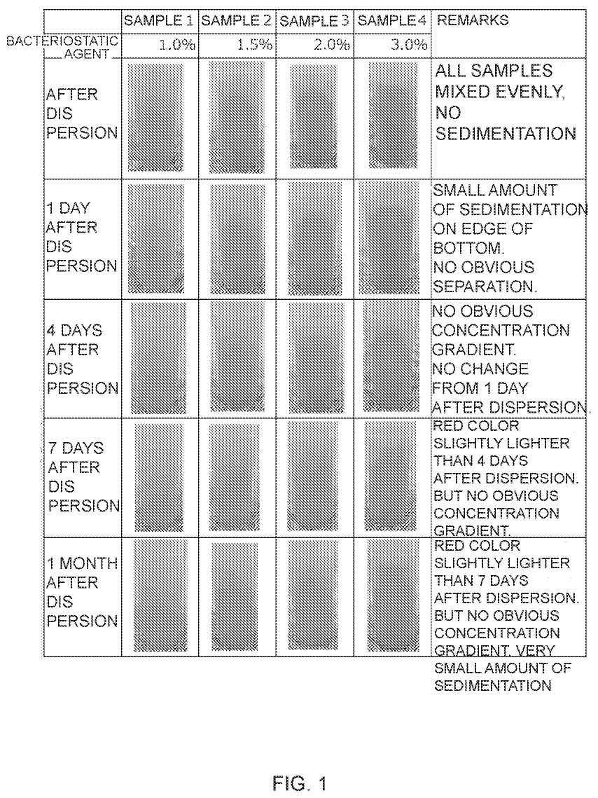

The results are shown in FIG. 1. Under all of the conditions examined, it was possible to maintain the sample oil and fat containing 3 mass % of the bacteriostatic agent in a dispersed state for at least one month, without the bacteriostatic agent being separated and precipitated.

6. Examination of Dispersion Conditions of Bacteriostatic Agent (1)

To examine a composition in which the lipophilic bacteriostatic agent is dispersed even with gentle stirring, the dispersion conditions of the lipophilic bacteriostatic agent were examined according to the following procedure. A sample containing only edible rapeseed oil (Sarasara Canola Oil (trademark) manufactured by Ajinomoto Co., Inc.) as the edible oil and fat (Sample 5), a sample containing the edible rapeseed oil (Sarasara Canola Oil (trademark) manufactured by J-Oil Mills, Inc.) as the edible oil and fat and 0.8 mass % of SY-Glyster CRS-75 (trademark, manufactured by Sakamoto Yakuhin Kogyo Co., Ltd., HLB 1) as emulsifier (Sample 6), and a sample containing the edible rapeseed oil (Sarasara Canola Oil (trademark) manufactured by Ajinomoto Co., Inc.) as the edible oil and fat and 0.8 mass % of POEM DO-100V (trademark, manufactured by Riken Vitamin Co., Ltd., HLB 7.4) and 0.08 mass % of Rikemal PO-100V (trademark, manufactured by Riken Vitamin Co., Ltd., HLB 3.6) as emulsifiers (Sample 7) were prepared. In addition, a lipophilic bacteriostatic agent (AR-274 (trademark), manufactured by Asama Co., Ltd.) colored with 1 mass % of red food coloring was separately prepared. Subsequently, 14.85 g of the sample oil and fat were added to 0.15 g of the lipophilic bacteriostatic agent. A magnetic stirrer (HS-3E manufactured by iuchi, Inc.) was set to perform gently stirring (level 2). The degree of dispersion of the colored lipophilic bacteriostatic agent after stirring for 1 minute was visually observed. In addition, conditions after stirred with a stirring force which gives uniformity of the lipophilic bacteriostatic agent until uniformity was achieved, were observed.

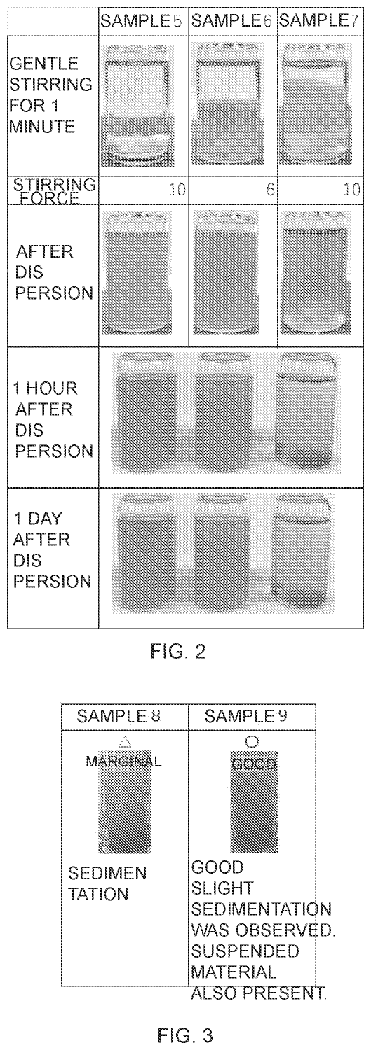

The results are shown in FIG. 2. By using a polyglycerol condensed ricinoleic acid ester (PGPR: CRS-75 (trademark)) having high W/O emulsifying strength, it was found that the lipophilic bacteriostatic agent easily disperses and further, the dispersion can be maintained even after one day. It was also found that, as a secondary effect, PGPR can give the pasta a glossy appearance.

7. Examination of Dispersion Conditions of Bacteriostatic Agent (2)

To examine the blending amount of emulsifier in edible oils and fats containing the lipophilic bacteriostatic agent, the dispersion conditions of the lipophilic bacteriostatic agent were examined by the following procedure. Sunsoft No. 81S (trademark, sorbitan monooleate, HLB 5.1, manufactured by Taiyo Kagaku Co., Ltd.) was used as an emulsifier. This emulsifier was dissolved in edible rapeseed oil (Sarasara Canola Oil (trademark) manufactured by J-Oil Mills, Inc.) as the edible oil and fat, to prepare a sample oil and fat containing 1 mass % of the emulsifier. In addition, a lipophilic bacteriostatic agent (AR-274 (trademark), manufactured by Asama Co., Ltd.) colored with 1 mass % of red food coloring was separately prepared. 1.8 g of the lipophilic bacteriostatic agent and 90 g of sample oil and fat were placed in a 100 mL plastic cup to prepare Sample 9. The sample was processed on a disperser at a speed of 7000 rpm for 2 minutes. As a comparison target, a sample (Sample 8) including the lipophilic bacteriostatic agent and the edible oil and fat, but not including the emulsifier, was prepared and similarly processed on a disperser. Subsequently, 80 g of the obtained sample were measured to be transferred into a 110 mL glass vial and allowed to stand at 24° C. After three days, the degree of sedimentation of the lipophilic bacteriostatic agent was visually observed and evaluated according to the following evaluation criteria, with reference to Sample 8.

(Evaluation criteria) Excellent: No sedimentation at all, Good: No sedimentation, Marginal: Sample 8, Poor: Strong sedimentation

The results are shown in FIG. 3. In the visual observation of the degree of sedimentation after three days, sedimentation of the lipophilic bacteriostatic agent was observed in Sample 8, but in Sample 9, only slight sedimentation was observed and the dispersibility was better than that in Sample 8.

8. Examination of Dispersion Conditions of Bacteriostatic Agent (3)

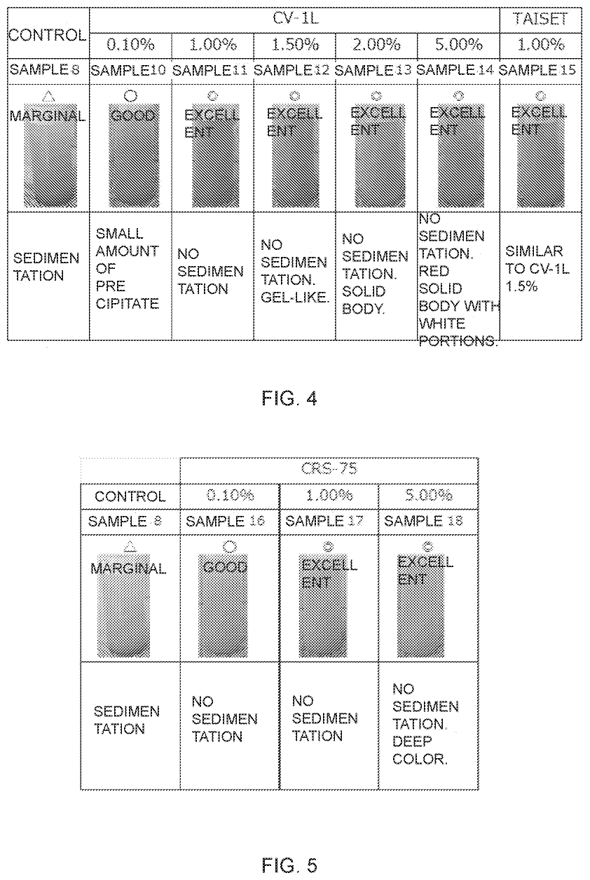

To examine the blending amount of emulsifier in edible oil and fat compositions containing the lipophilic bacteriostatic agent, the dispersibility of the lipophilic bacteriostatic agent was investigated. SY-Glyster CV-1L (trademark, HLB 2.7, manufactured by Sakamoto Yakuhin Kogyo Co., Ltd.) and TAISET AD (trademark, HLB 3.0, manufactured by Taiyo Kagaku Co., Ltd.) were used as emulsifiers. 0.1, 1, 1.5, 2, and 5 mass % of SY-Glyster CV-1L (trademark) and 1% of TAISET AD (trademark) were dissolved in edible rapeseed oil (Sarasara Canola Oil (trademark) manufactured by J-Oil Mills, Inc.) as the edible oil and fat, to prepare sample oils and fats (Samples 10 to 15) containing the emulsifiers. In addition, a lipophilic bacteriostatic agent (AR-274 (trademark), manufactured by Asama Co., Ltd.) colored with 1 mass % of red food coloring was separately prepared. 1.8 g of the bacteriostatic agent and 90 g of the sample oils and fats were placed in a 100 mL plastic cup, and the mixture was processed on a disperser at a speed of 7000 rpm for 2 minutes. Subsequently, 80 g of the obtained sample were measured to be transferred into a 110 mL glass vial and allowed to stand at 24° C. Sample 8 was used as the comparison target. After three days, the degree of sedimentation of the lipophilic bacteriostatic agent was visually observed and evaluated according to the following evaluation criteria, with reference to Sample 8. The results are shown in FIG. 4.

(Evaluation criteria) Excellent: No sedimentation at all, Good: No sedimentation, Marginal: Sample 8, Poor: Strong sedimentation

9. Examination of Dispersion Conditions of Bacteriostatic Agent (4)

To examine the blending amount of emulsifier in edible oil and fat compositions containing the lipophilic bacteriostatic agent, the dispersibility of the lipophilic bacteriostatic agent was investigated. 0.1, 1, and 5 mass % of SY-Glyster CRS-75 (trademark, HLB —2, manufactured by Sakamoto Yakuhin Kogyo Co., Ltd.) as emulsifier were dissolved in edible rapeseed oil (Sarasara Canola Oil (trademark) manufactured by J-Oil Mills, Inc.) as the edible oil and fat, to prepare sample oils and fats (Samples 16 to 18) containing the emulsifier. In addition, a lipophilic bacteriostatic agent (AR-274 (trademark), manufactured by Asama Co., Ltd.) colored with 1 mass % of red food coloring was separately prepared. 1.8 g of the bacteriostatic agent and 90 g of the sample oils and fats were placed in a 100 mL plastic cup, and the mixture was processed on a disperser at a speed of 7000 rpm for 2 minutes. Subsequently, 80 g of the obtained sample were measured to be transferred into a 110 mL glass vial and allowed to stand at 24° C. Sample 8 was used as the comparison target. After three days, the degree of sedimentation of the lipophilic bacteriostatic agent was visually observed and evaluated according to the following evaluation criteria, with reference to Sample 8. The results are shown in FIG. 5.

(Evaluation criteria) Excellent: No sedimentation at all, Good: No sedimentation, Marginal: Sample 8, Poor: Strong sedimentation

1. An edible oil and fat composition comprising:
an edible oil and fat;
acetic acid;
a lipophilic bacteriostatic agent; and
an emulsifier.

2. The edible oil and fat composition according to claim 1, wherein the lipophilic bacteriostatic agent is one or more types selected from the group consisting of thiamine lauryl sulfate, hop extract, yucca extract, mustard extract, capsicum extract, and licorice oil extract.

3. The edible oil and fat composition according to claim 1, wherein the emulsifier is one or more types selected from the group consisting of diglycerol ester, monoglycerol esters of organic acids, sucrose fatty acid ester, polyglycerol condensed ricinoleic acid ester, polyglycerol fatty acid ester, monoglycerol fatty acid ester, sorbitan fatty acid ester, and propylene glycol fatty acid ester.

4. The edible oil and fat composition according to any one of claim 1, wherein the content of the acetic acid is 0.1 to 10 mass %.

5. The edible oil and fat composition according to any one of claim 1, wherein the content of the lipophilic bacteriostatic agent is 0.002 to 10 mass %.

6. The edible oil and fat composition according to any one of claim 1, wherein the content of the emulsifier is 0.1 to 10 mass %.

7. The edible oil and fat composition according to any one of claim 1, wherein the content of the edible oil and fat is 70 mass % or more.

8. The edible oil and fat composition according to any one of claim 1, wherein the hydrophile-lipophile balance (HLB) of the emulsifier is 1 to 8.

9. A food product obtained by adding the edible oil and fat composition according to claim 1.
